(19) United States
(12) Patent Application Publication
(10) Pub. No.: US 2014/0101527 A1
(43) Pub. Date: Apr. 10, 2014

(54) Electronic Media Reader with a Conceptual Information Tagging and Retrieval System

(71) Applicant: Dominic Dan Suciu, Edmonds, WA (US)

(72) Inventor: Dominic Dan Suciu, Edmonds, WA (US)

(21) Appl. No.: 13/648,948

(22) Filed: Oct. 10, 2012

(51) Int. Cl. G06F 17/24

(52) U.S. Cl. CPC G06F 17/241
USPC 715/230

(57) ABSTRACT

By combining a media reader application with a tagging system, one creates an information tagging system that focuses the human reader on the task of assimilating knowledge into a conceptual model, thus enhancing the learning process. This disclosure combines the process of reading and consuming media with a process of associating concepts with a set of tags. These tags could represent questions or abstract concepts. When these tags are organized into conceptual model, they provide context for the learning process. This disclosure thereby makes reading and understanding a more simple and intuitive process, allowing much better data retrieval and recall, allowing far better understanding and contextualization of knowledge.

### PRIORITY OF APPLICATION

This application is a claims priority to provisional Application No. 61/545,198, filed Oct. 10, 2011, the entire contents of which are herein incorporated by reference for all purposes.

### FIELD

This disclosure relates to the display of electronic documents and/or other video, sound or image media files and more particularly to a method to enhance the organization and contextualization of the knowledge that is gleaned from such activity.

### BACKGROUND

Any subject that a human reader is trying learn begins with a set of questions or unknowns. Different types of subjects often have different sets of common questions that are abstractions of the subject matter. For example, languages can be loosely broken down into Vocabulary, Grammar, Culture, and Pronunciation. Science, Math and the Humanities have distinct topic abstractions that students and teachers often use as a hierarchical framework for study. Most knowledge representation, be it in the form of books, documents or videos, starts with an outline of the subject matter. As one reads a text, ideas conveyed by the writing gradually fill in the gaps of knowledge, until a completed picture emerges. Effective learning begins with the understanding of such an outline, and continues with the reader filling in the missing information. As these outlines grow, and become more informative, they become more than a simple list of questions. As knowledge is added, relationships emerge between each topic, and a loose set of topics gradually becomes a conceptual model. The process of effective learning is then the association of ideas and concepts into such a structured conceptual model.

When one is reading a new subject matter, one often takes notes down on paper. These notes often represent the reading in a chronological mode, where important fragmentary phrases chart the pathway through the text. Truly effective note taking takes place when the notes are structured around the topics and subtopics that are being learned. Effective note taking thus tends towards a representation of the subject matter as a conceptual model.

Electronic media readers are able to display and show electronic documents in the form of articles, books, videos, sound recording and images, media readers and viewers. There are major problems with current electronic document readers: In the first place, the files themselves and the information inside them are often hard to keep track of and organize, since such files are often presented to the human reader in a list form, which offers few options for effective organization and retrieval. Organizing documents is a tedious task, requiring the reading of the entire document or at least a portion of the document, and then either labeling the filename of the document with a relevant name or of placing the document into a folder that is also has a name that conveys the concept that is being captured herein. This process requires that a reader remember the name of the file itself, and then he/she must perform a separate set of actions in order to place the document into that organizing folder. The process of placing a document into a folder is a process of categorization. One places the document into a category, and the document will then reside in that folder. This process is incomplete however. Many documents may have multiple categories into which they belong. Furthermore, these categories may have relationships to each other that are more complex than the relationship implied by a folder within a folder relationship. Furthermore documents themselves being compositions of multiple concepts and ideas cannot easily be lumped together into a single category.

What is needed is an electronic media reader that allows not just the documents themselves, but portions thereof to be classified or tagged with concepts that are meaningful to the reader. These tags can then be organized into a conceptual framework that will allow easy retrieval and contextualization into larger frameworks of knowledge.

### SUMMARY

This Disclosure is an electronic media reader, viewer or player that allows a consumer to select documents or portions of documents and associate these to a set of concepts. These concepts are represented as tags which are short descriptive terms that can be added at will. Together, these tags can be further organized into conceptual frameworks that not only represent a model for a body of knowledge but also can be used for the retrieval of all associated files, annotations, and highlighted segments of a whole library of media files that have been assimilated by the reader him/herself. These conceptual models are more informative and more useful for representing knowledge.

This disclosure is a computer-implemented application that combines an electronic media reader with a method for tagging documents or portions of documents into a list of concepts or into a conceptual model. By combining electronic document display with the tagging of information into a conceptual model, this application allows a reader to create a mental map of the subject that is being read that is intimately associated with the primary material in his/her reading library. This process is thus a computer assisted abstraction of the process of note taking. The mental map that is generated allows the media consumer to easily organize ideas and content while consuming a electronic media document in a fluid way that does not interrupt the flow of ideas.

### BRIEF DESCRIPTION OF THE FIGURES

FIG. 1 illustrates one implementation of the present disclosure having at a minimum a electronic media reader, viewer or player and a functionality for selecting either a whole document or a portion of the document and assigning it to a tag.

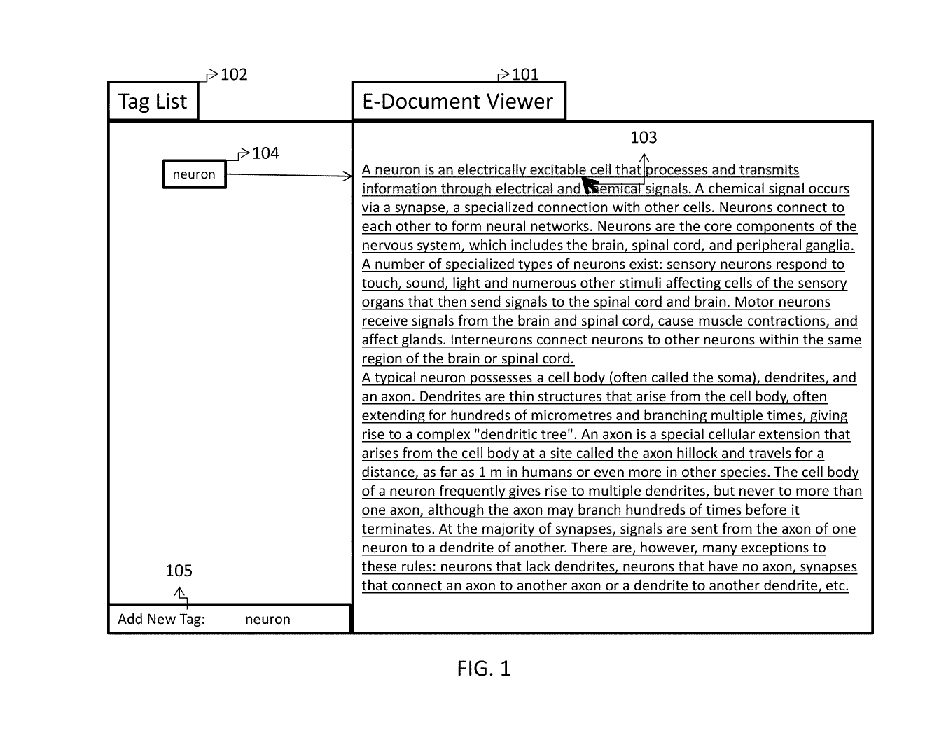

FIG. 2 shows how a one might associate different parts of an electronic media document to a set of tags that can be generated while consuming the media file.

FIG. 3 shows how one might effect the organization of the tags. It also displays how selecting one of the tags with a pointing device might retrieve or highlight pieces of text that have been associated with the tag by the reader.

FIG. 4 shows how the conceptual model on the left can be used to retrieve multiple media documents that have been associated with certain tags.

FIG. 5 shows how certain tags that have child relationships to other tags would retrieve representations of portions of media files that describe these concepts.

### DETAILED DESCRIPTION

Application: computer readable medium storing computer-executable instructions that has certain features. The computer on which this application can run can be a general-purpose computer or a computing device that is dedicated to the consumption of electronic media documents.

Electronic Media Documents: For written articles and image files, these files can be any of these file formats listed in the examples section as well as any future or current equivalent document format types that are designed to store and display electronic text, images and/or figures. For Audio media files, these files can be any of these file formats listed in the examples section as well as any future or current equivalent document format types that are designed to store and display audio. For Video media files, these files can be any of these file formats listed in the examples section as well as any future or current equivalent document format types that are designed to store and display video. For web pages, these files can be any of these file formats listed in the examples section as well as any future or current equivalent document format types that are designed to store and display web pages.

Annotation: An annotation is usually a comment written by a reader within a document or file. In this work, the term annotation is extended to also describe the process by which a document or a segment of a document is highlighted and selected, in addition to being commented. This can be effected by selecting a text interval, or by drawing a shape over a portion of the text, a part of a figure or image, a section of a webpage, an interval of video or sound file. It can also be performed by having the application generate a text box that can be filled in by the reader. An annotation may also encompass an entire document. An annotation can be performed using a click, an encircling or highlighting gesture, alternatively, there may be some algorithmic means for creating automatic annotations, based on the structure or parseable metadata of the media document. Each annotation could furthermore be associated with the actual file itself allowing easy access to the entire document.

E-Document Viewer/Player: The media reader application itself can have several embodiments: It may be used to read written or web page documents, view video or image documents, or play audio documents. Examples of such documents are listed here, but are not limited to the file formats listed below: For written articles and image files, these files can be any of these file formats as well as any future or current equivalent document format types that are designed to store and display electronic text, images and/or figures: 602—Text602 document, ABW—AbiWord document, ACL MS Word AutoCorrect List, CSV—ASCII text encoded as Comma Separated Values, used in most spreadsheets such as Microsoft Excel or by most database management systems, CWK—ClarisWorks/AppleWorks document, DOC—Microsoft Word document, DOCX—Office Open XML Text document or Microsoft Office Word 2007 for Windows/2008 for Mac, DOT—Microsoft Word document template, DOTX—Office Open XML Text document template, EGT—EGT Universal Document, FDX—Final Draft, FTM—Fielded Text Meta, FTX—Fielded Text (Declared), HTML—HyperText Markup Language (.html, .htm), HWP—Haansoft (Hancom) Hangul Word Processor document, HWPML—Haansoft (Hancom) Hangul Word Processor Markup Language document, LWP—Lotus Word Pro, MCW—Microsoft Word for Macintosh (versions 4.0-5.1), NB—Mathematica Notebook, NBP—Mathematica Player Notebook, ODM—OpenDocument Master document, ODT—OpenDocument Text document, OTT—OpenDocument Text document template, PAGES—Apple Pages document, PAP—Papyrus word processor document, PDAX—Portable Document Archive (PDA) document index file, PDF—Portable Document Format, Radix-64, RTF—Rich Text document, QUOX—Question Object File Format Question Object document for Quobject Designer or Quobject Explorer, RPT—Crystal Reports, SDW—StarWriter text document, used in earlier versions of StarOffice, STW—OpenOffice.org XML (obsolete) text document template, SXW—OpenOffice.org XML (obsolete) text document, TeX (.tex), Texinfo (.info), Troff, TXT—ASCII or Unicode plaintext, UOF—Uniform Office Format, UOML—UniqueObject Markup Language (UOML) is a XML-based markup language; uniqueobject, WPD—WordPerfect document, WPS—Microsoft Works document, WPT—Microsoft Works document template, WRD—WordIt! Document, WRF—ThinkFree Write, WRI—Microsoft Write document, XHTML (.xhtml, .xht)—eXtensible Hyper-Text Markup Language, XML—eXtensible Markup Language, XPS—Open XML Paper Specification, ASE—Adobe Swatch, ART—America Online proprietary format, BMP—Microsoft Windows Bitmap formatted image, BLP—Blizzard Entertainment proprietary texture format, CIT—Intergraph is a monochrome bitmap format, CPT—Corel PHOTO-PAINT image, CUT—Dr. Halo image file, DDS—DirectX texture file, DIB—Device-Independent Bitmap graphic, DjVu DjVu for scanned documents, EGT—EGT Universal Document, used in EGT SmartSense to compress PNG files to yet a smaller file, Exif—Exchangeable image file format (Exif) is a specification for the image file format used by digital cameras, GIF—CompuServe's Graphics Interchange Format, GPL—GIMP Palette, using a textual representation of color names and RGB values, ICNS—file format use for icons in Mac OS X. Contains bitmap images at multiple resolutions and bitdepths with alpha channel., ICO—a file format used for icons in Microsoft Windows. Contains small bitmap images at multiple resolutions and sizes., IFF (.iff, .ilbm, .Ibm)—ILBM, JNG—a single-frame MNG using JPEG compression and possibly an alpha channel., JPEG, JFIF (.jpg or .jpeg)—Joint Photographic Experts Group—a lossy image format widely used to display photographic images., JP2—JPEG2000, JPS—JPEG Stereo, LBM—Deluxe Paint image file, MAX—ScanSoft PaperPort document, MIFF—ImageMagick's native file format, MNG—Multiple Network Graphics, the animated version of PNG, MSP—a file format used by old versions of Microsoft Paint. Replaced with BMP in Microsoft Windows 3.0, NITF—A U.S. Government standard commonly used in Intelligence systems, OTA bitmap (Over The Air bitmap)—a specification designed by Nokia for black and white images for mobile phones, PBM—Portable bitmap, PC1—Low resolution, compressed Degas picture file, PC2—Medium resolution, compressed Degas picture file, PC3—High resolution, compressed Degas picture file, PCF—Pixel Coordination Format, PCX—a lossless format used by ZSoft's PC Paint, popular at one time on DOS systems., PDN—Paint.NET image file, PGM—Portable graymap, Pl1—Low resolution, uncompressed Degas picture file, Pl2—Medium resolution, uncompressed Degas picture file. Also Portrait Innovations encrypted image format., P13—High resolution, uncompressed Degas picture file, PICT, PCT—Apple Macintosh PICT image, PNG—Portable Network Graphic (lossless, recommended for display and edition of graphic images), PNM—Portable anymap graphic bitmap image, PNS—PNS—PNG Stereo, PPM—Portable Pixmap (Pixel Map) image, PSB—Adobe Photoshop Big image file (for large files), PSD, PDD—Adobe Photoshop Drawing, PSP Paint Shop Pro image, PX—Pixel image editor image file, PXR—Pixar Image Computer image file, QFX—QuickLink Fax image, RAW—General term for minimally processed image data (acquired by a digital camera), RLE—a run-length encoded image, SCT Scitex Continuous Tone image file, SGI, RGB, INT, BW—Silicon Graphics Image, TGA (.tga, .targa, .icb, .vda, .vst, .pix) Truevision TGA (Targa) image, TIFF (.tif or .tiff) Tagged Image File Format (usually lossless, but many variants exist, including lossy ones), TIFF/EP (.tif or .tiff)—ISO 12234-2; tends to be used as a basis for other formats rather than in its own right., XBM X Window System Bitmap, XCF—GIMP image (from Gimp's origin at the eXperimental Computing Facility of the University of California), XPM—X Window System Pixmap.

For Video media files, these files can be any of these file formats as well as any future or current equivalent document format types that are designed to store and display video: AAF—mostly intended to hold edit decisions and rendering information, but can also contain compressed media essence, 3GP—the most common video format for cell phones, GIF—Animated GIF (simple animation; until recently often avoided because of patent problems), ASF—container (enables any form of compression to be used; MPEG-4 is common; video in ASF—containers is also called Windows Media Video (WMV)), AVCHD—Advanced Video Codec High Definition, AVI—container (a shell, which enables any form of compression to be used), CAM—aMSN webcam log file, DAT—video standard data file (automatically created when we attempted to burn as video file on the CD), DSH, FLV—Flash video (encoded to run in a flash animation), M1V MPEG-1—Video, M2V MPEG-2—Video, FLA—Macromedia Flash (for producing), FLR—(text file which contains scripts extracted from SWF by a free ActionScript decompiler named FLARE), SOL—Adobe Flash shared object (“Flash cookie”), M4V (file format for videos for iPods and PlayStation Portables developed by Apple), Matroska (*.mkv)—Matroska is a container format, which enables any video format such as MPEG-4 ASP or AVC to be used along with other content such as subtitles and detailed meta information, WRAP—MediaForge (*.wrap), MNG—mainly simple animation containing PNG and JPEG objects, often somewhat more complex than animated GIF, QuickTime (.mov)—container which enables any form of compression to be used; Sorenson codec is the most common; QTCH is the filetype for cached video and audio streams, MPEG (.mpeg, .mpg, .mpe), MPEG-4 Part 14, shortened “MP4”—multimedia container (most often used for Sony's PlayStation Portable and Apple's iPod), MXF—Material Exchange Format (standardized wrapper format for audio/visual material developed by SMPTE), ROQ—used by Quake 3, NSV—Nullsoft Streaming Video (media container designed for streaming video content over the Internet), Ogg container, multimedia, RM—RealMedia, SVI—Samsung video format for portable players, SMI—SAMI Caption file (HTML like subtitle for movie files), SWF—Macromedia Flash (for viewing), WMV—Windows Media Video (See ASF).

For Audio media files, these files can be any of these file formats as well as any future or current equivalent document format types that are designed to store and display audio: Uncompressed:, AIFF—Audio Interchange File Format, AU, CDDA, IFF-8SVX, IFF-16SV, RAW—raw samples without any header or sync, WAV—Microsoft Wave, Compressed:, FLAC—(free lossless codec of the Ogg project), LA—Lossless Audio (.la), PAC—LPAC (.pac), M4A—Apple Lossless (M4A), APE—Monkey's Audio (APE), OptimFROG, RKA—RKAU (.rka), SHN—Shorten (SHN), TTA—free lossless audio codec (True Audio), WV—WavPack (.wv), WMA—Windows Media Audio 9 Lossless (WMA), Lossy audio:, AMR—for GSM and UMTS based mobile phones, MP2—MPEG Layer 2, MP3—MPEG Layer 3, Speex Ogg project, specialized for voice, low bitrates, GSM—GSM Full Rate, originally developed for use in mobile phones, WMA—Windows Media Audio (.WMA), AAC (.m4a, .mp4, .m4p, .aac) Advanced Audio Coding (usually in an MPEG-4 container), MPC—Musepack, VQF—Yamaha TwinVQ, RealAudio (RA, RM), OTS—Audio File (similar to MP3, with more data stored in the file and slightly better compression; designed for use with OtsLabs' OtsAV), SWA—Macromedia Shockwave Audio (Same compression as MP3 with additional header information specific to Macromedia Director, VOX—Dialogic ADPCM Low Sample Rate Digitized Voice (VOX), VOC—Creative Labs Soundblaster Creative Voice 8-bit & 16-bit (VOC), DWD—DiamondWare Digitized (DWD), SMP—Turtlebeach SampleVision (SMP).

For web pages, these files can be any of these file formats as well as any future or current equivalent document format types that are designed to store and display web pages: Static:, dtd, Document Type Definition (standard), MUST be public and free, RNA—(.rna)—lime Network Real Native Application File, XML—(.xml)—eXtensible Markup Language, HTML—(.html, .htm)—HyperText Markup Language, XHTML—(.xhtml, .xht)—eXtensible HyperText Markup Language, MHTML—(.mht, .mhtml)—Archived HTML, store all data on one web page (text, images, etc.) in one big file, Dynamically generated:, ASP—(.asp)—Microsoft Active Server Page, ASPX—(.aspx)—Microsoft Active Server Page. NET, ADP—AOLserver Dynamic Page, BML—(.bml)—Better Markup Language (templating), CFM—(.cfm)—ColdFusion, CGI—(.cgi), iHTML—(.ihtml)—Inline HTML, JSP—(.jsp) JavaServer Pages, Lasso—(.las, .lasso, .lassoapp), PL—Perl (.pl), PHP—(.php, .php?, .phtml)—? is version number (previously abbreviated Personal Home Page, later changed to PHP: Hypertext Preprocessor), SSI—(.shtml)—HTML with Server Side Includes (Apache), SSI—(.stm)—HTML with Server Side Includes (Apache).

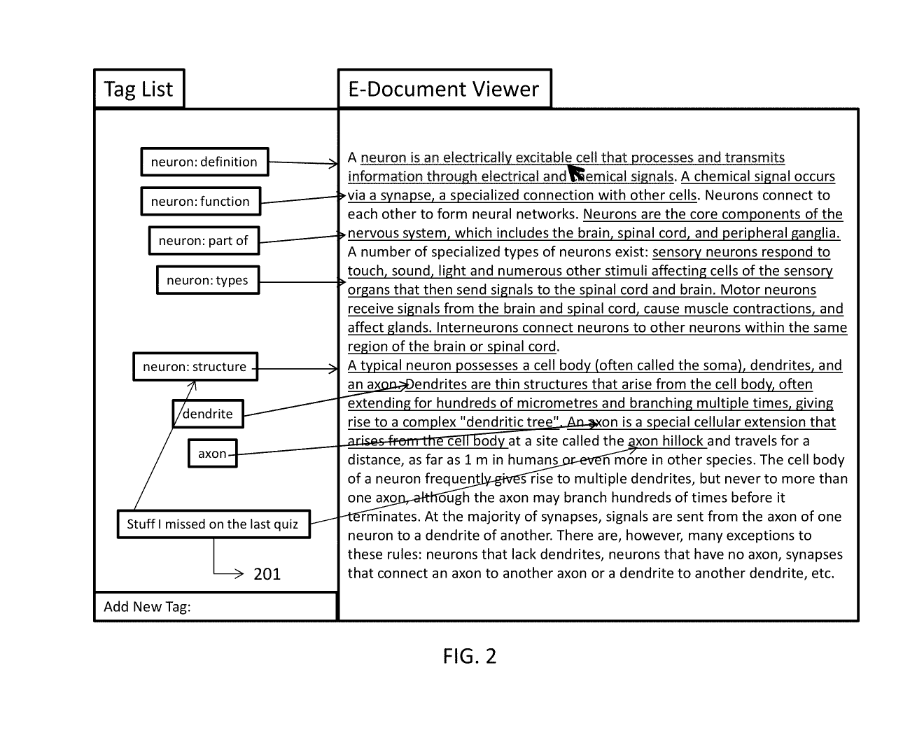

Tag List: A tag list is a list of subjects that the user is interested in. The tags that are used to describe a subject can be, though are not limited to any abstract or concrete notion: It can be an idea, topic, concept, subject category, notion or question. They could also be a name with a predicate that further describes the object. For example in FIG. 2, neuron is one such tags as are neuron:function, neuron:structure, neuron:part of, etc. In another embodiment, they can be a list of questions or a set of topics that one is interested in. These lists can represent folders in a directory, or else they can function simply as meta-tags that one may use to describe a piece of knowledge.

Tagging: Tagging is the process by which a reader associates a documents or annotations of documents with any of the tags from the tag list. The application will provide for one of several methods for associating an annotation or an actual file with a tag. Tag lists can be restricted to a single document or they may span multiple documents from the reader's library.

Conceptual Model: Tags within a tag list can be arranged into a conceptual model. Predicates can be used to specify such an association. The subject-predicate-object paradigm for concept representation is a well understood concept in semantics. An incomplete list of common predicates includes: is, is related to, is part of, is adjacent to, is contained by, etc. In one embodiment, this conceptual model can be represented by a graph. In graph theory, graphs are composed of nodes and edges. Any given graph has a topology which is described by the relationship of its nodes as given by the edges. In this view, the individual tags, are the nodes of a graph. The predicates are the edges of the graph. The combination of tags and their associative predicates creates different graph topologies. Predicates can further describe unary or transitive relationships between any two tags. These relationships may imply precedence or superiority or equivalency. The resultant model would describe a generalized graph structure. In another embodiment, certain predicates might describe a parent-child relationship, thus the structure would represent a hierarchical graph structure, where tags that are higher up in the conceptual model would contain tags that are below them in the model. Under this case, parent tags could contain child tags as well as their annotations and documents. A sub-graph is a part of a graph starting from a single node, and all its associated nodes.

Synchronization: The application that is described herein manipulates a data structure stored in memory on one machine that maintains a representation of the list of tags, the list of annotations of media files, and their associations given by the tagging events. In one embodiment, this application would allow the generation of an ordering and tagging information on one computing device to be synchronized with another computing device.

By combining a media reader application with a tagging system, one creates an information tagging system that focuses the reader on the task of answering specific questions. These questions could be derived from an unassociated list of tags, or else these questions can be made implicit by the structure of the conceptual model itself. It thereby makes reading and understanding a more simple and intuitive process. The reader is thus able to place the annotation into a conceptual framework. This process allows much better data retrieval and recall. This process is also a far better method for understanding and contextualizing knowledge. These are critical features of efficient learning.

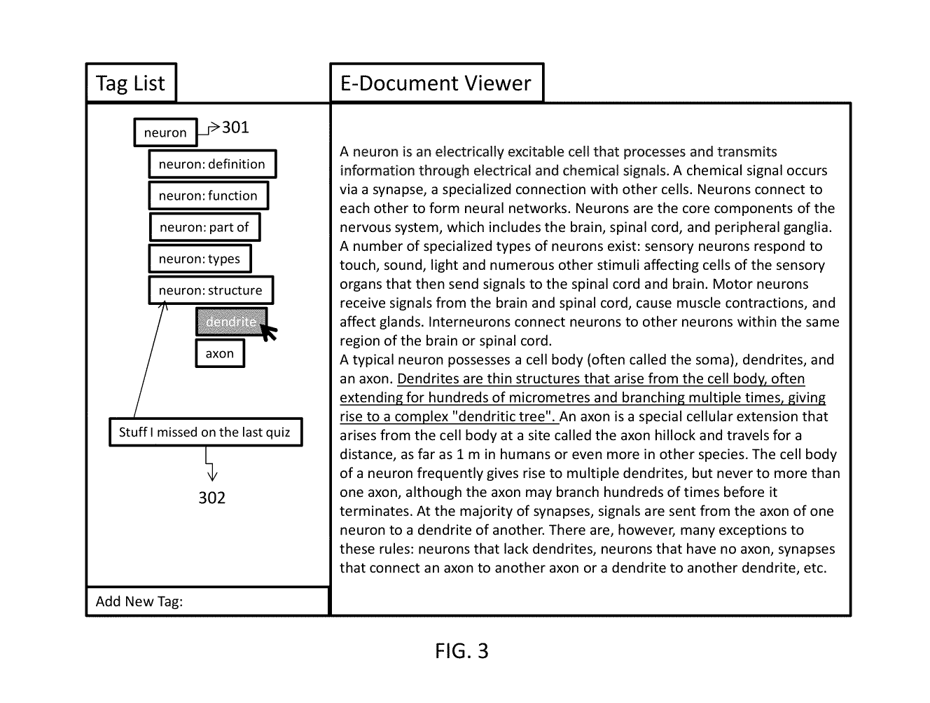

At its simplest level, this disclosure combines a media reader 101 with a tagging system 102. Once a document or a portion of a document has been selected 103, one could add a comment to the selection. The application would also give the user the option of tagging the annotation, by associating it one or multiple pre-defined tags 104. One may also add any number of new tags as necessary 105. The arrows in the figure mapping tags to the selected annotation/selections are shown for illustrative purposes only. Eventually, many portions of an electronic media document will be associated with a subset of tags (FIG. 2). The application would then allow manipulation and organization of the tags into a conceptual model that allows the establishment of a relationship between the different tags. One could start out with a poorly defined list of tags, and through the reading process, a proper relationship may appear to the user (FIG. 3) based on her understanding of the material. The user would order the tags into various arrangements or topologies that best describe the relationships of the tags to each other. Tags can be arranged in an outline form 301. In this case, modifiers of the term neuron are arranged in a hierarchical fashion under the neuron heading. The tag ‘neuron’ itself would be subheaded under the tag ‘nervous system’ 501. In another embodiment, the tags could be arranged in the form of a graph database, having nodes connected by predicates. In this way, not only can the tags themselves be associated with annotations within the text, but the predicates that describe these relationships within the conceptual model could be associated with annotations within the text.

In one embodiment, the application could also include a conceptual model generator, whereby tags are added as objects and associated using predicates, as defined above. They may furthermore be derived from the structure of the document itself by the user or through some automated means. These conceptual models could even be provided by the document author him/herself.

In a further embodiment, these conceptual models could be imported from other users or other applications. The conceptual model could be a public ontology describing a body of knowledge. Such an ontology might be imported as a list of tags that have a pre-determined relationship to each other, and tagging would simply involve associating portions and files in a reader's electronic media library to tags or nodes within these pre-existing or imported conceptual models. Several formats already exist for describing ontologies. These include RDF-XML, OBO, OBO-XML, OWL. One could also use a conceptual model stored within a relational database model.

In further embodiment, the tags can be a mixture of tags that belong within a conceptual model and tags that refer to concerns or concepts that need not be organized into a larger conceptual model. For example Tag 201 ‘stuff I missed on the last quiz’ could be used to tag not only individual text annotations or selections but also other tags. These are part of the ‘questions’ one generates when one sets out to read a set of documents. This tag 301 ends up not being used as part of the larger conceptual model, and yet it points to other tags.

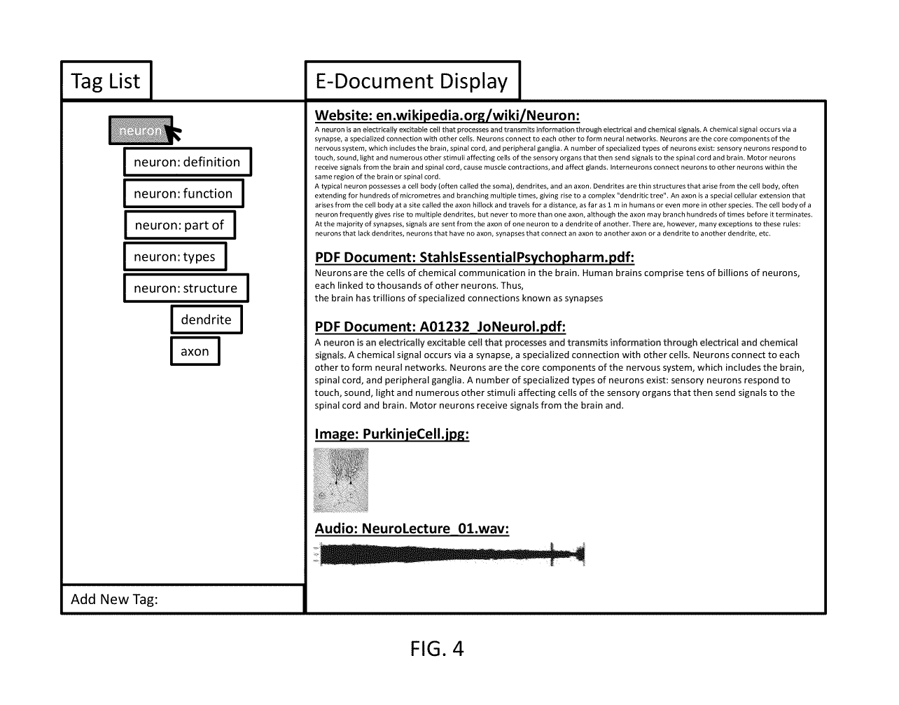

This disclosure is designed to allow the media consumer to assimilate primary material into abstract concept models. It is also designed to allow said consumer to organize and retrieve documents and portions of documents based on concepts, concerns or questions, represented as tags that the reader finds important. FIG. 3 shows how an E-document Viewer is able to highlight annotations within a document that are associated with a tag that has been selected by the consumer. The same application also affords views of the annotations that have been tagged by the reader in multiple files across his entire collection of documents (FIG. 4). These annotations can be represented as Icons of images or text. They may be presented in whatever order a user may choose: chronologically, by document, by reading session, or more effectively by association with the tags. Furthermore, presenting the annotations in the context of the conceptual model, would create a structured view of the knowledge that has been read and tagged along the way. This would allow the reader the ability to visualize the information she has read and assimilated, but when displayed as part of a larger conceptual framework, it allows the reader to see what information is tsill missing.

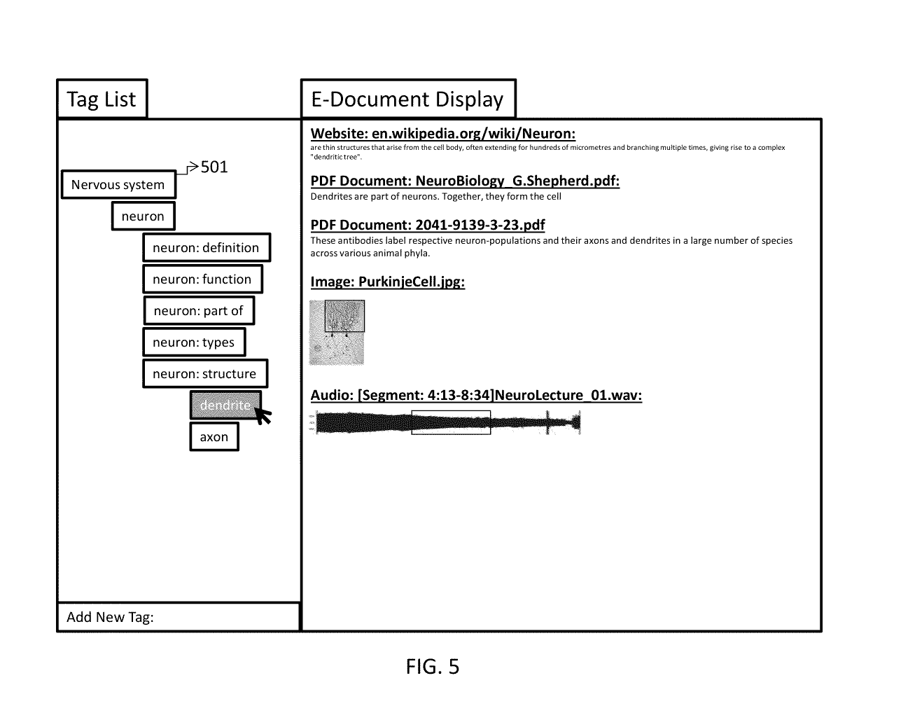

In one embodiment, selecting tags that are higher up in the hierarchical construct of the tag model would select child tags and items also. Tags that have more restricted scope, that refer to child nodes within the conceptual model would be expected to highlight distinct files as well as smaller sections within larger files (FIG. 5). In this way, the application may also present the user with features that give the user selectivity in his ability to search the document library and annotation library, by selecting subsets of tags or by selecting nodes within the graph described by the conceptual model.

This disclosure claims five elements: 1. A media reader that allows one to view, display, or play electronic media documents. 2. An ability to annotate either an entire document or a section of a document. 3. An ability to associate an annotation with a concept as embodied by a tag. 4. A way in which to organize these tags into a conceptual model that posits various relationships between these tags. 5. The ability to tag and to search across multiple files and documents.

Several products exist on the market that combine a media reader with a method for outlining parts of text and generating annotations (iAnnotate by Branchfire, San Francisco, Calif.; Papers, by mekentosj, Aalsmeer, The Netherlands; Adobe Acrobat, Adobe, Seattle, Wash.; Preview, Apple, Cupertino, Calif.; PDF-XChange Viewer, Tracker Software Products, Chemainus, BC; GoodReader, Good.iWare). While most of these programs allow a user to annotate a document by making a selection within the document and creating a note around the selection, none have the ability to tag a selected portion of text. The program EverNote (Redwood City, Calif.) has the ability to associate a set of tags with individual notes that are generated by a reader, but it does not allow you to associate a tag with particular annotation or text selection.

The concept of PDF electronic media readers has been the subject of several patent applications, but none capture the entire disclosure of this application: U.S. Pat. Appl. No 20120079372 embodies the concept of selecting parts of documents, and tagging those parts to an abstract concept; however, there is no conception of being able to order these tags into a conceptual model. Pat. Appl. No. 20110261030 and 20100161653 have many of these elements but like 20120079372 are missing the ability to organize tags into a conceptual model. Pat. Appl. No. 20110261030 and Pat. Appl. No. 20110041099 lacks any conception of extending tag associations across multiple files. This is the same situation with Pat. Appl. No. 20080028292, which lacks both the ability to organize tags as well as extend the tags across multiple files.

It is the combination of tags that can be associated with each other in meaningful ways and the ability to combine knowledge across multiple files that creates a tool that allows one to organize and assimilate knowledge across an entire library of electronic media files. After all, it is neither rote memorization nor the copying down of ideas onto paper that promotes true learning. It is instead the placement of knowledge into a larger context of understanding that achieves this. This disclosure makes this possible.

What is claimed is:

1. A computer-readable medium containing computer-executable instructions which when executed causes the computer to perform:
viewing or playing of an electronic media document,
the displaying of a set of tags,
controlling of a pointer by which a human operator can manipulate and point to said electronic media document,
controlling of said pointer by which said human operator can manipulate to point to said tag in order to indicate a tagging request
an underlying memory data structure that stores the list of tags, the list of annotations of media files, and their associations given by said tagging requests wherein said user is able to associate said electronic media documents with any subset of tags, thus allowing easy organization of collections of documents.

2. The feature of claim 1 that allows annotations and/or selections of said documents to be made.

3. The feature from claim 1 whereby the said set of tags can be organized into a conceptual model.

4. The feature of claim 3 whereby a single annotation or electronic media document can be tagged to multiple tags.

5. The feature of claim 1 whereby tagging an annotation or electronic media document to one tag, by the nature of the topology of the conceptual model, implies association with other tags.

6. A feature of claim 1 that would display said set of tags along with a visual representation of the associated annotations and/or electronic media documents.

7. A feature of claim 1 that would display said set of tags in the form of a conceptual model along with a visual representation of the associated annotations and/or electronic media documents.

8. A feature of claim 1 that would display a representation of the file or annotation once a document is selected during the tagging process, but before tagging action is completed, allowing a confirmation for said human operator of the correct selection.

9. A feature for the selection and retrieval of annotations and/or electronic media documents to be performed by selecting a set of tags.

10. A feature for the selection and retrieval of annotations and/or electronic media documents to be performed by selecting nodes within a conceptual model.

11. A feature of claim 1 whereby the said data structure can be synchronized with other computing devices.
